(19) United States
(12) Patent Application Publication
(10) Pub. No.: US 2025/0124799 A1
(43) Pub. Date: Apr. 17, 2025

(54) Latent Skill Model-Based Teacher

(71) Applicant: Toyota Research Institute, Inc., Los Altos, CA (US)

(72) Inventors: Guy Rosman, Newton, MA (US); Jonathan A. DeCastro, Arlington, MA (US); Deepak Gopinath, Los Altos, CA (US); Emily Sumner, Los Altos, CA (US); Xiongyi Cui, Somerville, MA (US); Wolfram Burgard, Los Altos, CA (US); Avinash Balachandran, Los Altos, CA (US); Hiroshi Yasuda, San Carlos, CA (US); Jean Costa, Los Altos, CA (US)

(73) Assignees: Toyota Research Institute, Inc., Los Altos, CA (US); Toyota Jidosha Kabushiki Kaisha, Toyota-shi (JP)

(21) Appl. No.: 18/778,917

(22) Filed: Jul. 19, 2024

Related U.S. Application Data
(60) Provisional application No. 63/543,631, filed on Oct. 11, 2023.
(60) Provisional application No. 63/543,639, filed on Oct. 11, 2023.

(51) Int. Cl. G09B 5/02; B60W 50/14; G06N 3/0455; G09B 5/04

(52) U.S. Cl. CPC G09B 5/02; B60W 50/14; G06N 3/0455; G09B 5/04; B60W 2050/146; B60W 2540/30

(57) ABSTRACT

A teaching curriculum method for generating teaching actions for drivers, includes obtaining driving data from a plurality of driving scenarios, the driving data comprises vehicle trajectory information and corresponding scene context information, the driving scenarios comprising instructed driving events and uninstructed driving events, encoding, with a behavior model, the driving data, wherein the encoded driving data comprises an indication that a corresponding one of the driving scenarios comprises one of the instructed driving event or the uninstructed driving event, determining, with a trajectory estimator processing the encoded driving data, one or more driving skill transitions based on a presence or an absence of the indication, and generating, with a teacher action model, a teaching action for one of the plurality of driving scenarios.

### CROSS-REFERENCE TO RELATED APPLICATIONS

This application claims the benefit of prior filed U.S. Provisional Patent Application No. 63/543,631 filed on Oct. 11, 2023 and claims the benefit of prior filed U.S. Provisional Patent Application No. 63/543,639 filed on Oct. 11, 2023, each of which are incorporated herein by reference in their entireties.

### TECHNICAL FIELD

The present disclosure relates to techniques for training a skill advancement model for a driver and generating a teaching action for the driver.

### BACKGROUND

Implementation and utilization of artificial intelligence (AI) in the field of education continues to grow. Attempts to implement and utilize AI tools have been made in the areas of making recommendations to human users, carrying out interactions with a human user to influence human behavior, and others. Current AI tools are focused on learning control policies that incorporate natural language feedback from users. Some current AI tools can automatically generate language corrections to a human user, but the AI tools do so by implementing vague corrective utterances or extremely specific corrective instructions. These corrections do not provide helpful content for training a human user to improve a skill, such as a driving maneuver or driving related action. There is a need to improve the training and implementation of AI tools for advancing the skills of a human driver.

### SUMMARY

One aspect provides an apparatus configured for generating teaching actions for drivers. The apparatus includes one or more memories; and one or more processors coupled to the one or more memories and configured to cause the apparatus to: obtain driving data from a plurality of driving scenarios, the driving data comprises vehicle trajectory information and corresponding scene context information, the plurality of driving scenarios comprising instructed driving events and uninstructed driving events; encode, with a behavior model, the driving data, wherein the encoded driving data comprises an indication that a corresponding one of the plurality of driving scenarios comprises one of the instructed driving events or the uninstructed driving events; determine, with a trajectory estimator processing the encoded driving data, one or more driving skill transitions based on a presence or an absence of the indication; cause a teacher action model to learn a teacher policy encoding from the determined one or more driving skill transitions and the encoded driving data; and generate, with the teacher action model, a teaching action for one of the plurality of driving scenarios.

Another aspect provides a method for generating teaching actions for drivers. The method includes obtaining driving data from a plurality of driving scenarios, the driving data comprises vehicle trajectory information and corresponding scene context information, the plurality of driving scenarios comprising instructed driving events and uninstructed driving events; encoding, with a behavior model, the driving data, wherein the encoded driving data comprises an indication that a corresponding one of the plurality of driving scenarios comprises one of the instructed driving events or the uninstructed driving events; determining, with a trajectory estimator processing the encoded driving data, one or more driving skill transitions based on a presence or an absence of the indication; and generating, with a teacher action model, a teaching action for one of the plurality of driving scenarios.

Another aspect provides a teaching curriculum generation system including a behavior encoder, a latent dynamics and decoder module, a teacher action model, and a reward estimator, where the behavior encoder encodes a past trajectory of the driver, additional control signals in the car, and map information; the latent dynamics decoder module enables learning of skill transition over time based on teacher actions; the teacher action model encodes a teacher policy as well as estimates of utility and/or future value of different teaching actions; and the rewards estimator characterizes rewards in terms of student advancement and satisfaction in response to teacher actions.

These and additional features provided by the embodiments described herein will be more fully understood in view of the following detailed description, in conjunction with the drawings.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals.

FIG. 1 depicts an illustrative schematic of the artificial intelligence (AI) model comprising a skill advancement model and a teacher action model, according to embodiments described herein.

FIG. 2 depicts a system for training the skill advancement model for a driver and generating a teaching action for the driver with the teach action model of the AI model, according to embodiments described herein.

FIG. 3 depicts an illustrative diagram of the AI model for training a skill advancement model for a driver and generating a teaching action for the driver, according to embodiments described herein.

FIG. 4 depicts an illustrative schematic of the language reward model, according to embodiments described herein.

FIG. 5 depicts an illustrative schematic of the automated teaching cues instructor model according to embodiments described herein.

FIG. 6 depicts a flowchart of a method for generating teaching actions for drivers, according to embodiments described herein.

FIG. 7 depicts an example processing system configured to perform the methods described herein, according to embodiments described herein.

### DETAILED DESCRIPTION

Aspects of the present disclosure provide apparatuses, methods, processing systems, and computer-readable mediums for training a skill advancement model for a driver and generating a teaching action for the driver. As will be appreciated from the details provided herein, aspects of the present disclosure are directed to approaches for training a skill advancement model for a driver from driving data corresponding to various driving scenarios, so as to offer improved in-vehicle driver teaching systems in addition to auto-generating curriculum for student driver training.

Current AI tools may be trained and configured to identify driving actions and based on prescribed rules corresponding to the driving actions, manually coded feedback can be provided to the driver. However, manually coded feedback templates are not able to be generalized across multiple domains or driving scenarios. Accordingly, implementation of current AI tools and manually coded feedback based systems have performance gaps and technical limitations with respect lacking the capability of generating teaching actions for novel driving scenarios, which cannot be further tailored to learn teaching actions (e.g., feedback) that advances a driver's skills.

Aspects of the present disclosure provide technical solutions to the technical problem, for example, by implementing multi-task learning to the problem of training a machine-learning teacher in combination with an estimator to determining whether or not to emit a teaching cue and condition future behavior prediction and resulting metrics on whether teaching was provided. This allows the value of that cue to be replaced at training time, and separate training of teaching examples' future behavior regression from non-teaching examples' future behavior, to improve the features that are learned from the more abundant non-teaching examples data.

It is understood that multi-task learning is a training paradigm in which machine learning models are trained with data from multiple tasks simultaneously, using shared representations to learn the common ideas between a collection of related tasks. These shared representations provide the technical benefits of increasing data efficiency and potentially yielding faster learning speed for related or downstream tasks, helping to alleviate the weaknesses of deep learning arising from large-scale data requirements and the corresponding computational demand.

As will be described in more detail herein, aspects of the present provide an approach to train an AI model including a teacher action model and a skill advancement model from driving data obtained from a plurality of driving scenarios. The driving data includes a variety of features corresponding to driving actions, for example, but not limited to vehicle trajectory information, scene context information, driver awareness, and the like. The driving data corresponds to driving scenarios that include instructed driving events and uninstructed driving events. For example, instructed driving events refer to instances where a teaching action was provided to the driver. The teaching action may be a vague language instruction, such as apply the brake, or a detailed interaction that is context specific to the driving event. The variety of teaching actions captured in the instructed driving events enables the AI model to learn which teaching action, for example, through statistical analysis, provides the best advancement in the driver's skill over time. The driving scenarios may also include uninstructed driving events which enable the AI model during training to separate driving behaviors conditioned on teaching actions and those that may naturally learned by a driver through trial and error or iteration.

The approach allows the AI model to learn efficiently from both instructed data, uninstructed data by combining multi-task training with skills and behavior prediction and separating behavior to be conditioned on whether or not instructions are happening. The inclusion of an explicit variable providing an indication that “teaching is happening” or not with trajectory prediction has shown to help training the AI model with respect to teaching cues and actions.

Aspects of the AI model including the teacher action model and the skill advancement model described herein have a neural network are trained from trajectory or map encoders and additional vehicle signals, which enable a model of driver capabilities. The teacher action model may be trained to provide automated teaching cues based on a mix of non-teaching driving data, self-labeled performance metrics, and teaching examples, for example, either teaching action choices or demonstrations of teaching. Since there is an teaching examples are scarce, the more abundant non-teaching driving data and self-labeled performance metrics can help train the teacher action model of the AI model.

The following will now describe these systems and methods in more detail with reference to the drawings and where like numbers refer to like structures

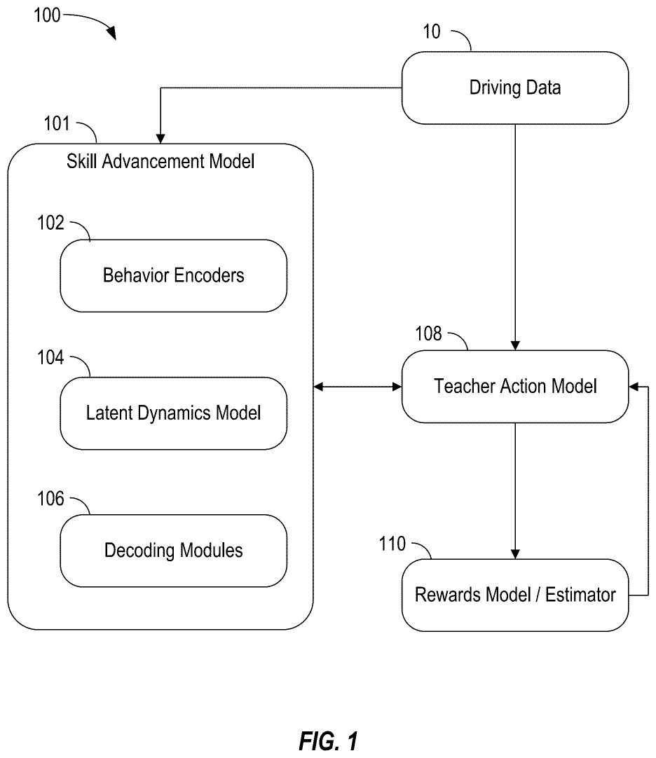

FIG. 1 depicts an illustrative schematic of the AI model 100 comprising a skill advancement model 101, a teacher action model 108, and optionally and a rewards model/estimator 110 according to embodiments described herein. The skill advancement model 101 includes behavior encoders 102, latent dynamics model 104, decoding modules 106. The behavior encoders 102 encode driving data 10, for example including past trajectories of the driver, additional control signals in the car, map information, and the like, similar to trajectory prediction approaches. The latent dynamics model 104 and decoding modules 106 enable learning of skill transition over time, as a function of teacher actions. The skill transition of a driver over time corresponds to an estimation of a driver's skill in engaging in driving acts as it changes over time in response to teacher actions. The teacher action model 108 encodes a teacher policy as well as estimates of the utility/future value of different teaching actions. The teacher policy may be verbal, visual, and/or sensory type teacher actions configured to convey feedback and training to the driver. For example, a visual teacher action may include a displaying a racing line on a heads-up display or other display in the vehicle. A verbal teacher action may be include voice instructions provided through the speakers. A sensory feedback teacher action may include force feedback steering or seat vibrations to convey instruction or feedback to the driver.

The teacher policy defines the level of detail and type of cues or instructions. For example, some users may be receptive to corrective cues, while others require explanations in addition to direction for performing actions in order to advance their skills, such as operating a vehicle. In some aspects, the teacher action model 108 may be paired with the rewards model/estimator 110. The rewards model/estimator 110 is either learned or manually set. This part characterizes the rewards in terms of student advancement and satisfaction in response to teacher actions.

The modules may be trained, in a semi-supervised fashion from large-scale driving data 10 with data annotated with a skill assessment, to infer a latent estimate of current skills of the driver, along with data corresponding to how that skill changes given teacher actions.

Aspects of the present disclosure may learn a partially observable Markov decision process (POMDP) where the latent states are unobserved at runtime. The latent dynamics model 104 and decoding modules 106 encode the learned POMDPs. The teacher action model 108 may then be trained to produce estimates of which teacher actions are good, for example, as a mapping from a current scenario and student skill estimate. Furthermore, once a model of skill dynamics is produced, a long-term plan can be generated, for example, by sampling-based planning techniques, A* search algorithm, or other planning approaches, to produce a curriculum.

In some aspects, the rewards model/estimator 110 may be trained to rank possible teacher sentences conditioned on the current driving context.

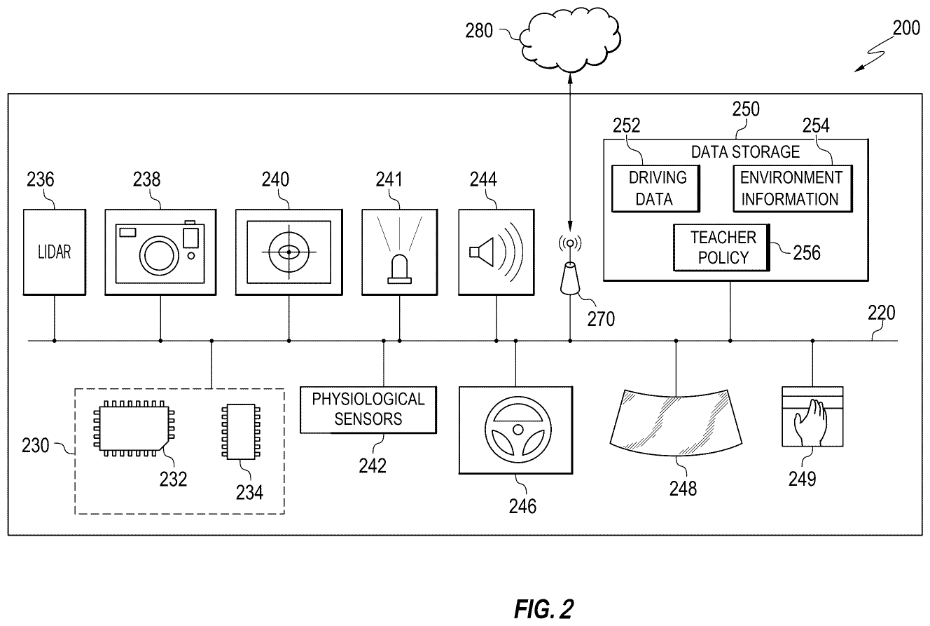

FIG. 2 depicts a system 200 for training the skill advancement model for a driver and generating a teaching action for the driver with the teach action model of the AI model. In some aspects, the system 200 may include an electronic control unit 230. The electronic control unit 230 may include a processor 232 and a memory component 234. The system 200 may also include a communication bus 220, a LIDAR system 236, one or more cameras 238, a gaze-tracking system 240, an illuminating device 241, one or more physiological sensors 242, a speaker 244, a steering wheel system 246, a heads-up display system 248, a vehicle display 249, a data storage component 250 and/or network interface hardware 270. As referred to herein, the term “one or more environment sensors” may include the LIDAR system 236, one or more cameras 238, and/or a variety of other sensor systems capable of ascertaining information about the environment around a vehicle and functionality of the vehicle such as a vehicle speed, a rate of acceleration or deceleration of the vehicle, a vehicle location, a vehicle heading, or the like. The system 200 may be communicatively coupled to a network 280 by way of the network interface hardware 270. The components of the system 200 are communicatively coupled to each other via the communication bus 220.

It is understood that the embodiments depicted and described herein are not limited to the components or configurations depicted and described with respect to FIG. 2, rather FIG. 2 is merely for illustration. The various components of the system 200 and the interaction thereof will be described in detail below.

The communication bus 220 may be formed from any medium that is capable of transmitting a signal such as, for example, conductive wires, conductive traces, optical waveguides, or the like. The communication bus 220 may also refer to the expanse in which electromagnetic radiation and their corresponding electromagnetic waves traverses. Moreover, the communication bus 220 may be formed from a combination of mediums capable of transmitting signals. In one embodiment, the communication bus 220 comprises a combination of conductive traces, conductive wires, connectors, and buses that cooperate to permit the transmission of electrical data signals to components such as processors 232, memories, sensors, input devices, output devices, and communication devices. Accordingly, the communication bus 220 may comprise a bus. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The communication bus 220 communicatively couples the various components of the system 200. As used herein, the term “communicatively coupled” means that coupled components are capable of exchanging signals with one another such as, for example, electrical signals via conductive medium, electromagnetic signals via air, optical signals via optical waveguides, and the like.

The electronic control unit 230 may be any device or combination of components comprising a processor 232 and the memory component 234. The processor 232 of the system 200 may be any device capable of executing the machine-readable instruction set stored in the memory component 234. Accordingly, the processor 232 may be an electric controller, an integrated circuit, a microchip, a field programmable gate array, a computer, or any other computing device. The processor 232 is communicatively coupled to the other components of the system 200 by the communication bus 220. Accordingly, the communication bus 220 may communicatively couple any number of processors 232 with one another, and allow the components coupled to the communication bus 220 to operate in a distributed computing environment. Specifically, each of the components may operate as a node that may send and/or receive data. While the embodiment depicted in FIG. 2 includes a single processor 232, other embodiments may include more than one processor 232.

The memory component 234 of the system 200 is coupled to the communication bus 220 and communicatively coupled to the processor 232. The memory component 234 may be a non-transitory computer readable memory and may comprise RAM, ROM, flash memories, hard drives, or any non-transitory memory device capable of storing machine-readable instructions such that the machine-readable instructions can be accessed and executed by the processor 232. The machine-readable instruction set may comprise logic or algorithm(s) written in any programming language of any generation (e.g., 1GL, 2GL, 3GL, 4GL, or 5GL) such as machine language that may be directly executed by the processor 232, or assembly language, object-oriented programming (OOP), scripting languages, microcode, etc., that may be compiled or assembled into machine readable instructions and stored in the memory component 234. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. While the system 200 depicted in FIG. 2 includes a single memory component 234, other embodiments may include more than one memory component 234.

Still referring to FIG. 2, in some embodiments, the system 200 may include a LIDAR system 236. The LIDAR system 236 is communicatively coupled to the communication bus 220 and the electronic control unit 230. The LIDAR system 236 is used in a light detection and ranging system that uses pulsed laser light to measure distances from the LIDAR system 236 to objects that reflect the pulsed laser light. The LIDAR system 236 may be made of solid-state devices with few or no moving parts, including those configured as optical phased array devices where its prism-like operation permits a wide field-of-view without the weight and size complexities associated with a traditional rotating LIDAR sensor. The LIDAR system 236 is particularly suited to measuring time-of-flight, which in turn can be correlated to distance measurements with objects that are within a field-of-view of the LIDAR system 236.

The system 200 may also include one or more cameras 238. The one or more cameras 238 may be communicatively coupled to the communication bus 220 and to the processor 232. The one or more cameras 238 may be any device having an array of sensing devices (e.g., pixels) capable of detecting radiation in an ultraviolet wavelength band, a visible light wavelength band, or an infrared wavelength band. The one or more cameras 238 may have any resolution. The one or more cameras 238 may be an omni-directional camera, or a panoramic camera, for example. In some embodiments, one or more optical components, such as a mirror, fish-eye lens, or any other type of lens may be optically coupled to each of the one or more cameras 238. In embodiments described herein, the one or more cameras 238 may capture image data or video data of an environment of a vehicle.

The system 200 may include a gaze-tracking system 240 for tracking an eye or gaze direction of a subject to generate a gaze direction vector for determining where a driver is looking. The gaze-tracking system 240 may include one or more cameras 238 and/or an array of infrared light detectors positioned to view one or more eyes of a subject. The gaze-tracking system 240 may also include or be communicatively coupled to an illuminating device 241 which may be an infrared or near-infrared light emitter. The illuminating device 241 may emit infrared or near-infrared light, which may be reflected off a portion of the eye creating a profile that is more readily detectable than visible light reflections off an eye for eye-tracking purposes.

The gaze-tracking system 240 may be spatially oriented in an environment and generate a gaze direction vector. One of a variety of coordinate systems may be implemented such as user coordinate system (UCS). For example, the UCS has its origin at the center of the front surface of the gaze-tracker. With the origin defined at the center of the front surface (e.g., the eye-tracking camera lens) of the gaze-tracking system 240, the gaze direction vector may be defined with respect to the location of the origin. Furthermore, when spatially orienting the gaze-tracking system 240 in the environment, all other objects including the one or more cameras 238 may be localized with respect to the location of the origin of the gaze-tracking system 240. In some embodiments, an origin of the coordinate system may be defined at a location on the subject, for example, at a spot between the eyes of the subject. Irrespective of the location of the origin for the coordinate system, a calibration process may be employed by the gaze-tracking system 240 to calibrate a coordinate system for collecting gaze-tracking data for training the neural network.

Still referring to FIG. 2, the system 200 may further include one or more physiological sensors 242. The one or more physiological sensors 242 may be communicatively coupled to the communication bus 220 and to the processor 232. The one or more physiological sensors 242 may be any device capable of monitoring and capturing physiological states of the human body, such as a driver's stress level through monitoring electrical activity of the heart, skin conductance, respiration, or the like. The one or more physiological sensors 242 may provide indication as to the driver's response to a teacher action. The one or more physiological sensors 242 include sensors configured to measure bodily events such as heart rate change, electrodermal activity (EDA), muscle tension, and cardiac output. The one or more physiological sensors 242 may monitor brain waves through electroencephalography, EEG, electrodermal activity through a skin conductance response, SCR, and galvanic skin response, GSR, cardiovascular measures such as heart rate, HR; beats per minute, BPM; heart rate variability, HRV; vasomotor activity, muscle activity through electromyography, EMG, changes in pupil diameter with thought and emotion through pupillometry (e.g., pupillometry data), eye movements, recorded via the electro-oculogram, EOG and direction-of-gaze methods, and cardiodynamics recorded via impedance cardiography, or other physiological measures.

The physiological sensors 242 may generate physiological response data that may be utilized to train or evolve a neural network to determine a state of awareness of a driver. For example, a speed of change, the degree of change, or the intensity of the resulting physiological condition such as the speed or amount of pupil dilation or elevation in heart rate may be captured by the one or more physiological sensors 242. The observed changes may be translated into a state of awareness of conditions within the environment.

The system 200 may also include a speaker 244. The speaker 144 (i.e., an audio output device) is coupled to the communication bus 220 and communicatively coupled to the processor 232. The speaker 244 transforms audio message data as signals from the processor 232 of the electronic control unit 230 into mechanical vibrations producing sound. For example, the speaker 244 may provide to the driver a notification, alert, or teacher action such as an instruction to the driver generated by the teacher action model. The notification may include prompts such as an estimate as to how much time until a handback event, information about the environment such as “entering a construction zone, prepare to assume control of the vehicle,” or other information to alert the driver of a predicted handback event. However, it should be understood that, in other embodiments, the system 200 may not include the speaker 244.

The steering wheel system 246 is coupled to the communication bus 220 and communicatively coupled to the electronic control unit 230. The steering wheel system 246 may comprise a plurality of sensors located in the steering wheel for determining a driver grip on the steering wheel, the degree of rotation applied to the steering wheel or the forces applied in turning or maintaining the steering wheel or a teacher action such as a sensory instruction to the driver generated by the teacher action model. The steering wheel system 246 may provide signals to the electronic control unit 230 indicative of the location and number of hands on the steering wheel, the strength of the grip on the steering wheel, or changes in position of one or more hands on the steering wheel. The steering wheel system 246, for example, without limitation, may include pressure sensors, inductive sensors, optical sensors, or the like. In addition to detecting the location, number, grip and change in position of one or more hands on the steering wheel, the steering wheel system 246 may also include one or more sensors indicating the rotational angle of the steering wheel and corresponding signals to the electronic control unit 230. The steering wheel system 246 may include motors or components to provide haptic feedback to the driver. For example, the steering wheel system 246 may be configured to provide vibrations of varying intensity through the steering wheel to indicate actions the driver should implement.

The heads-up display system 248 may be included with the system 200 for presenting visual indications, such as a teacher action to the driver generated by the teacher action model. For example, a heads-up display system 248 may present a trajectory indication to the driver to follow. A heads-up display system 248 may be a display device integrated with the windshield or other display device within the vehicle. In some embodiments, the heads-up display system 248 may include a projector that projects images onto the windshield through one or more lens systems. However, this is only one example implementation of a heads-up display system 248.

The system 200, for example, as implemented in a vehicle, may include a vehicle display 249. The vehicle display 249 may be a display device. The display device may include any medium capable of transmitting an optical output such as, for example, a cathode ray tube, light emitting diodes, a liquid crystal display, a plasma display, or the like. The vehicle display 249 may be configured to display a visual alert or warning message, or teacher action such as an instruction generated by the teacher action model. The vehicle display 249 may also include one or more input devices. The one or more input devices may be any device capable of transforming user contact into a data signal that can be transmitted over the communication bus 220 such as, for example, a button, a switch, a knob, a microphone or the like. In some embodiments, the one or more input devices include a power button, a volume button, an activation button, a scroll button, or the like. The one or more input devices may be provided so that the user may interact with the vehicle display 249, such as to navigate menus, make selections, set preferences, and other functionality described herein. In some embodiments, the input device includes a pressure sensor, a touch-sensitive region, a pressure strip, or the like.

A data storage component 250 that is communicatively coupled to the system 200 may be a volatile and/or nonvolatile digital storage component and, as such, may include random access memory (including SRAM, DRAM, and/or other types of random access memory), flash memory, registers, compact discs (CD), digital versatile discs (DVD), and/or other types of storage components. The data storage component 250 may reside local to and/or remote from the system 200 and may be configured to store one or more pieces of data (e.g., driving data 252, environment information 154, and/or teacher policy 256) for access by the system 200 and/or other components. As illustrated in FIG. 1, the data storage component 250 stores, for example, driving data 152 that may include information from one or more environment sensors recorded during past or current driving events. The driving data 252 may include image data, LIDAR data, speed data, location information, navigation or route information, acceleration or deceleration activity, or the like. The driving data 252 may be segmented into sets of data where a first set of driving data 252 includes information corresponding to a driving scenario including instructed driving events. A second set of driving data 252 may include information corresponding to a driving scenario including uninstructed driving events.

The data storage component 250 may also include environment information 254. The environment information 254 includes information generated by one or more environment sensors. In some embodiments, the information from the one or more environment sensors may be temporarily stored in the data storage component 250 before processing by the electronic control unit 230. While in some embodiments, the environment information 254 is recorded for later analysis or use in training the AI model.

The data storage component 250 may also include one or more teacher policies 256. The one or more teacher policies 256 define learned teaching actions may be used for automated online instruction of a driver and/or development of teaching curriculum tailored to the particular driver to advance one or more of their driving skills.

Still referring to FIG. 2, the system 200 may also include network interface hardware 270 that is communicatively coupled to the electronic control unit 230 via the communication bus 220. The network interface hardware 270 may include any wired or wireless networking hardware, such as a modem, LAN port, Wi-Fi card, WiMax card, mobile communications hardware, and/or other hardware for communicating with a network 280 and/or other devices and systems. For example, the system 200 may be communicatively coupled to a network 280 by way of the network interface hardware 270.

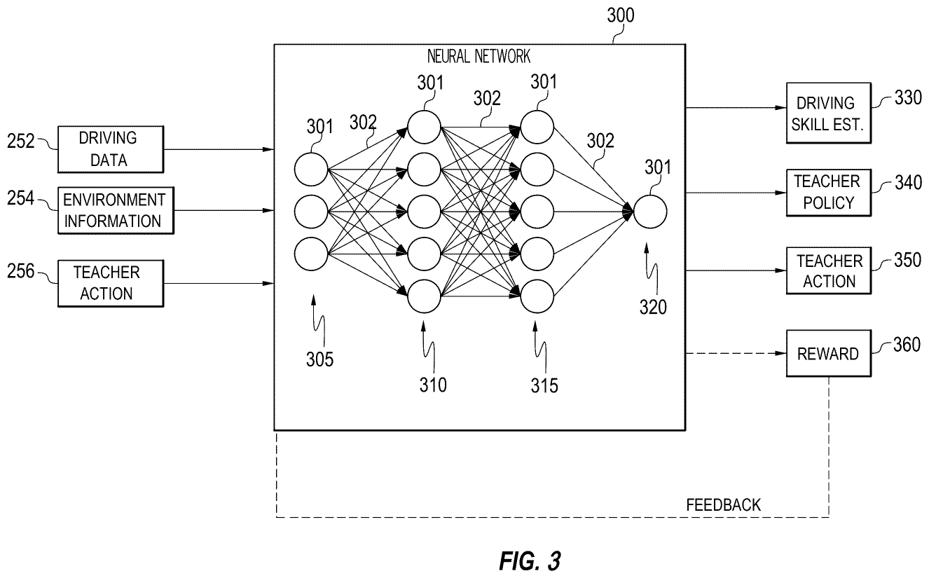

Turning to FIG. 3, an illustrative diagram of the AI model 300 (e.g., corresponding to the AI model 100 of FIG. 1) for training a skill advancement model for a driver and generating a teaching action for the driver is depicted. In some aspects, the AI model 300 is depicted as a neural network which may include one or more layers 305, 310, 315, 320, having one or more nodes 301, connected by node connections 302. The one or more layers 305, 310, 315, 320, may include an input layer 305, one or more hidden layers 310, 315, and an output layer 320. The input layer 305 represents the raw information that is fed into the neural network. For example, driving data 252, environment information 254 from one or more environment sensors (e.g., the LIDAR system 136 and/or one or more cameras 138), and one or more teacher actions corresponding to instructed driving events may be input into the neural network at the input layer 305. The neural network processes the raw information received at the input layer 305 through nodes 301 and node connections 302. For example, a behavior model of the AI model 300 may encode the driving data 252. The encoded driving data comprises an indication that a corresponding one of the driving scenarios comprises one of the instructed driving event or the uninstructed driving event. The neural network, for example, one or more layers or modules configured as a trajectory estimator processes the encoded driving data to determine one or more driving skill transitions based on a presence or an absence of the indication.

The one or more hidden layers 310, 315, depending on the inputs from the input layer 305 and the weights on the node connections 302, carry out computational activities. In other words, the hidden layers 310, 315 perform computations and transfer information from the input layer 305 to the output layer 320 through their associated nodes 301 and node connections 302.

In general, when the AI model 300 is learning, the neural network identifies and determines patterns within the raw information received at the input layer 305. In response, one or more parameters, for example, weights associated to node connections 302 between nodes 301, may be adjusted through a process known as back-propagation. It should be understood that there are various processes in which learning may occur, however, two general learning processes include associative mapping and regularity detection. Associative mapping refers to a learning process where a neural network learns to produce a particular pattern on the set of inputs whenever another particular pattern is applied on the set of inputs. Regularity detection refers to a learning process where the neural network learns to respond to particular properties of the input patterns. Whereas in associative mapping the neural network stores the relationships among patterns, in regularity detection the response of each unit has a particular ‘meaning’. This type of learning mechanism may be used for feature discovery and knowledge representation. Moreover, aspects of the AI model 300 provided herein are configured as multi-task learning models.

Neural networks possess knowledge that is contained in the values of the node connection weights. Modifying the knowledge stored in the network as a function of experience implies a learning rule for changing the values of the weights. Information is stored in a weight matrix W of a neural network. Learning is the determination of the weights. Following the way learning is performed, two major categories of neural networks can be distinguished: 1) fixed networks in which the weights cannot be changed (i.e., dW/dt=0) and 2) adaptive networks that are able to change their weights (i.e., dW/dt not=0). In fixed networks, the weights are fixed a priori according to the problem to solve.

In order to train a neural network to perform some task, adjustments to the weights are made in such a way that the error between the desired output and the actual output is reduced. This process may require that the neural network compute the error derivative of the weights (EW). In other words, it must calculate how the error changes as each weight is increased or decreased slightly. A back propagation algorithm is one method that is used for determining the EW.

The algorithm computes each EW by first computing the error derivative (EA), the rate at which the error changes as the activity level of a unit is changed. For output units, the EA is simply the difference between the actual and the desired output. To compute the EA for a hidden unit in the layer just before the output layer, first all the weights between that hidden unit and the output units to which it is connected are identified. Then, those weights are multiplied by the EAs of those output units and the products are added. This sum equals the EA for the chosen hidden unit. After calculating all the EAs in the hidden layer just before the output layer, in like fashion, the EAs for other layers may be computed, moving from layer to layer in a direction opposite to the way activities propagate through the neural network, hence “back propagation”. Once the EA has been computed for a unit, it is straightforward to compute the EW for each incoming connection of the unit. The EW is the product of the EA and the activity through the incoming connection. It should be understood that this is only one method in which a neural network is trained to perform a task.

Referring back to FIG. 3, the neural network may include one or more hidden layers 310, 315 that feed into one or more nodes 301 of an output layer 320. There may be one or more output layers 320 depending on the particular output the neural network is configured to generate. For example, the AI model 300 may be trained to output a driving skill estimate 330 which indicates the level of a driver's skill in performing a driving action. The AI model 300 may output a teacher policy 340 that is learned from the determined one or more driving skill transitions and the encoded driving data. The AI model 300 may determine a teacher action for one of the plurality of driving scenarios. The AI model 300 may also determine a reward 360 which characterizes the a driver's advancement and satisfaction in response to teacher actions. The reward 360 may be fed back to the AI model 300 to further learn and generate teacher actions that improve a driver's skill.

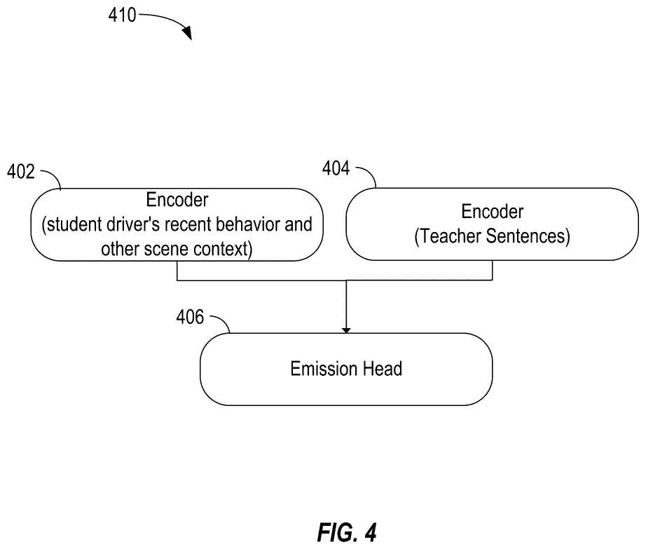

In some aspects, the AI model 300 may include a language reward model 410. FIG. 4 depicts an illustrative schematic of the language reward model 410 is depicted. A language reward model 410 is employed to allow efficient learning of good teaching sentences, based on how they influence the future student actions, thereby allowing to generate teaching cues, or even dialogues that are conditioned on how the driver is driving as well as sentence inputs from the driver.

The approach enables training of action-conditioned language models (generation of teacher sentences given the past driving behavior and other context-specific information such as local maps, DMS feeds, etc.) by utilizing a learned reward model 410 that encourages a specific driving behavior in the future. In some aspects, the reward model 410 is configured as a neural network map from past student driving actions along with additional context-relevant information and teacher sentences generated by the language model into the expected effect on the student's future behavior.

Learning a teacher model and skill advancement model as a neural network from trajectory/map encoders and additional vehicle signals enables a rich model of driver capabilities, and its use for statistics and skill display applications, direct use for automated online instructors, and even longer range teaching curriculum generation (preset plans tailored to the student driver).

The reward model 410, as depicted in FIG. 4, is constructed with an encoder 402 of the student driver's recent behavior, and other scene context such as map encoder, an encoder 404 of the teacher sentence, e.g. based on a language attention model and an additional fine tuning approach, such as prefix tuning or low-rank approximation; and an emission head 406 that generates an estimate of future skill changes or other regressed properties of student behavior.

The reward model 410 is trained by exposing the network to tuples of past student behavior, given teacher sentences, and using the model to regress a set of future skill statistics and/or behavior properties, such as average speed, safety measurements, rates satisfaction from polls, or other desirability measures. The reward model 410 can then be used to train or tune a teaching sentence generator given past trajectory, generate teacher sentences, and optionally along with direct examples of past trajectory and teacher sentences, or more traditional reward models. Another example use case includes the use of the reward model within a dialog system, where the generated sentences are part of a student and teacher dialog, conditioned on the driver's past behavior and scenario/map context. Techniques of the present disclosure provide an estimator capable of estimating the expected change in statistics/future behavior reward conditioned on a teacher instruction text and the past scenario information.

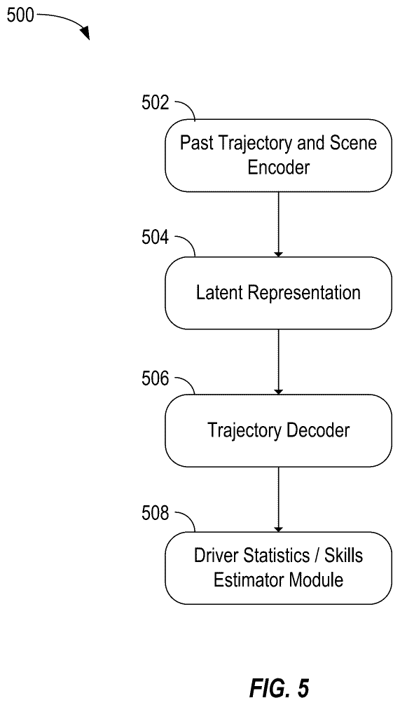

In some aspects, the AI model 300 may be configured to interface with an automated teaching cues instructor model 500. FIG. 5 depicts an illustrative schematic of the automated teaching cues instructor model 500 according to embodiments described herein. The automated teaching cues instructor model of the present disclosure includes a past trajectory and scene encoder 502, a latent representation 504, a trajectory decoder 506, and a driver statistics/skills estimator module 508. The past trajectory and scene encoder 502 is associated with the human's past behavior and scene/map context. The latent representation 504 incorporates whether there is an instructor giving instructions. The trajectory decoder 506 emits future driving trajectories conditioned on the instructor's presence and their recent predicted/ground-truth instructions. In one instantiation, the trajectory decoder 506 depends on an explicit estimation of whether the instructor or teacher should give teaching cues and/or instructions. The driver statistics/skills estimator module 508 generates estimates based on skills including, for example, driving time, deviation from racing line, variability of the speeds and accelerations, and side slip angle statistics, on different road segments/time horizons.

The approach enables the model 500 to learn efficiently from both instructed data and uninstructed data by combining multi-task training with skills and behavior prediction and separating behavior based on whether or not instructions were provided.

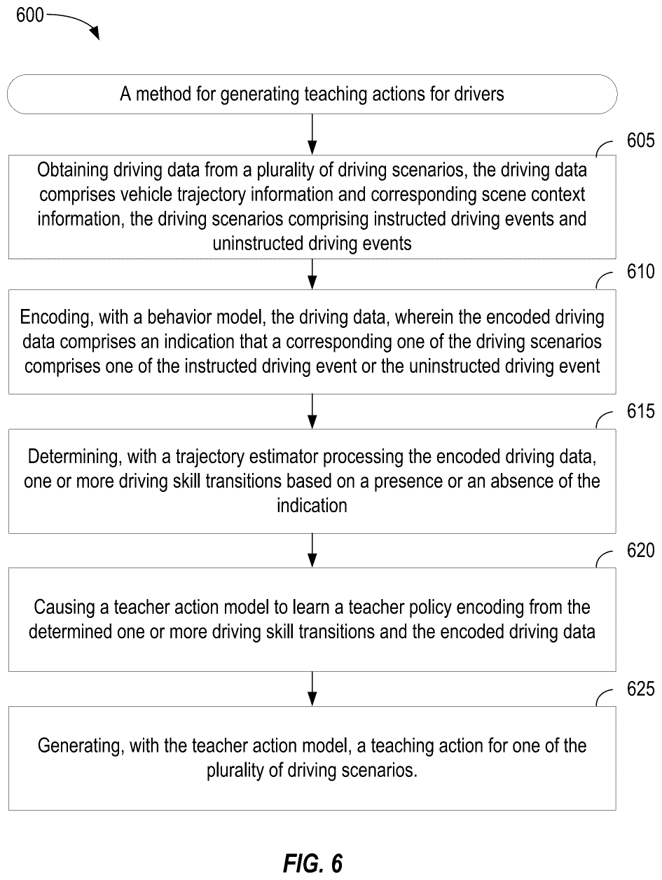

FIG. 6 depicts a flowchart of a method for generating teaching actions for drivers, according to one or more embodiments shown and described herein.

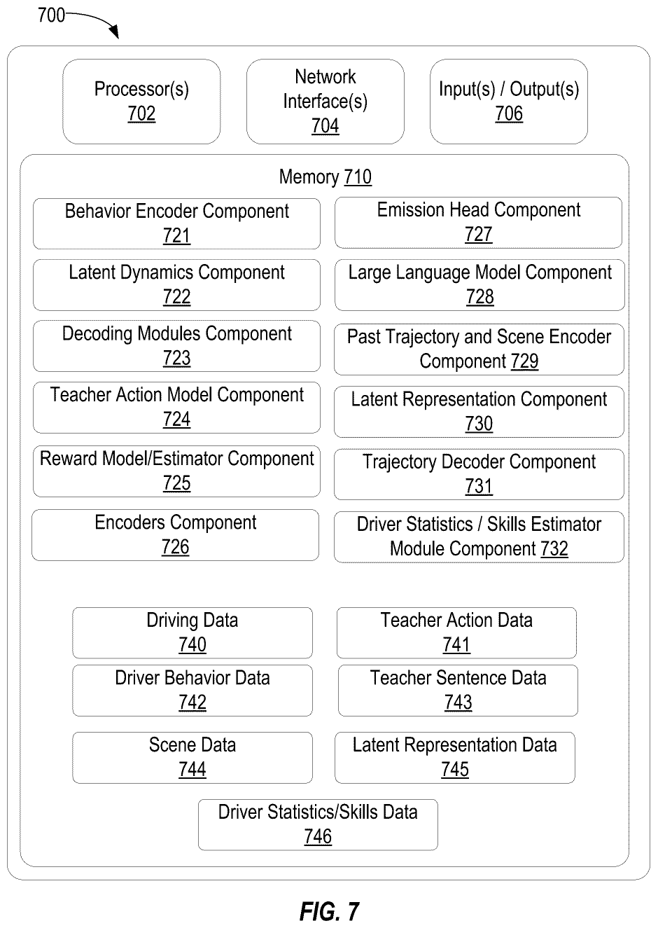

In this example, method 600 begins at step 605 with obtaining driving data from a plurality of driving scenarios, the driving data comprises vehicle trajectory information and corresponding scene context information, the driving scenarios comprising instructed driving events and uninstructed driving events. For example, step 605 may be performed by the system 200 described above with reference to FIG. 2 or the processing system 700 described with reference to FIG. 7.

Method 600 proceeds to step 610 with encoding, with a behavior model, the driving data, wherein the encoded driving data comprises an indication that a corresponding one of the driving scenarios comprises one of the instructed driving event or the uninstructed driving event. In some aspects, the process of encoding by step 610 may be performed by the system 200 described above with reference to FIG. 2 or the processing system 700 described with reference to FIG. 7. For example, the process of encoding may be implemented by the AI model 300 described herein.

Method 600 proceeds to step 615 with determining, with a trajectory estimator processing the encoded driving data, one or more driving skill transitions based on a presence or an absence of the indication. In some aspects, the process of determining by step 615 may be performed by the system 200 described above with reference to FIG. 2 or the processing system 700 described with reference to FIG. 7. For example, the process of determining may be implemented by the AI model 300 described herein.

Method 600 proceeds to step 620 with causing a teacher action model to learn a teacher policy encoding from the determined one or more driving skill transitions and the encoded driving data. In some aspects, the process of determining by step 620 may be performed by the system 200 described above with reference to FIG. 2 or the processing system 700 described with reference to FIG. 7. For example, the process of causing a teacher action model to learn a teacher policy encoding from the determined one or more driving skill transitions and the encoded driving data may be implemented by the AI model 300 described herein.

Method 600 proceeds to step 625 with generating, with the teacher action model, a teaching action for one of the plurality of driving scenarios. In some aspects, the process of determining by step 625 may be performed by the system 200 described above with reference to FIG. 2 or the processing system 700 described with reference to FIG. 7. For example, the process of generating may be implemented by the AI model 300 described herein.

FIG. 7 depicts an example processing system 700 configured to perform the methods described herein. The processing system 700 implements the AI model 300 as described herein.

Processing system 700 includes one or more processors 702. Generally, processor(s) 702 may be configured to execute computer-executable instructions (e.g., software code) to perform various functions, as described herein.

Processing system 700 further includes a network interface(s) 704, which generally provides data access to any sort of data network, including personal area networks (PANs), local area networks (LANs), wide area networks (WANs), the Internet, and the like.

Processing system 700 further includes input(s) and output(s) 706, which generally provide means for providing data to and from processing system 700, such as via connection to computing device peripherals, including user interface peripherals.

Processing system further includes a memory 710 configured to store various types of components and data.

In this example, memory 710 includes a behavior encoder component 721, a latent dynamics component 722, a decoding modules component 723, a teacher action model component 724, a reward model/estimator component 725, an encoders component 726, a emission head component 727, a large language model component 728, a past trajectory and scene encoder component 729, a latent representation component 730, a trajectory decoder component 731, and a driver statistics/skills estimator module component 732.

In some aspects, the AI model includes a behavior encoder component 721, a latent dynamics component 722, a decoding modules component 723, a teacher action model component 724, a reward model/estimator component 725, and optionally an encoders component 726 configured to perform steps 605-625. For example, the behavior encoder component 721 obtains driving data 740 and encodes the driving data, wherein the encoded driving data comprises an indication that a corresponding one of the driving scenarios comprises one of the instructed driving event or the uninstructed driving event of step 610.

The latent dynamics component 722 of the AI model is utilized to determine, with a trajectory estimator processing the encoded driving data, one or more driving skill transitions based on a presence or an absence of the indication of step 615.

In turn, the teacher action model component 724 is configured to perform step 620 which includes at least causing the teacher action model to learn a teacher policy encoding from the determined one or more driving skill transitions and the encoded driving data. The teacher action model learns a teaching policy (e.g., teacher actions) that a generalized for a driving scenario and that will be best received by a driver to improve their driving skills. For example, the teaching policy for a driver may be more than mere directions such as apply the brake to stop. For example, for a driver having trouble with the skill of braking such that they hard brake often, a teaching policy may include instructions as to when to start applying the brake and how to gradually apply pressure. An example of a teaching action may include verbal, visual, and/or sensory feedback.

The teacher action model component 724, when trained, is configured to generate a teaching action for one of the plurality of driving scenarios.

In this example, memory 710 also includes driving data 740, teacher action data 741, driver behavior data 742, teacher sentence data 743, scene data 744, latent representation data 745, and driver statistics/skills data 746.

Processing system 700 may be implemented in various ways. For example, processing system 700 may be implemented within on-site, remote, or cloud-based processing equipment.

Processing system 700 is just one example, and other configurations are possible. For example, in alternative embodiments, aspects described with respect to processing system 700 may be omitted, added, or substituted for alternative aspects.

### Additional Considerations

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It will be apparent to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments, but should be defined only in accordance with the following claims and their equivalents.

What is claimed is:

1. An apparatus configured for generating teaching actions for drivers, comprising:
one or more memories; and one or more processors coupled to the one or more memories and configured to cause the apparatus to:
obtain driving data from a plurality of driving scenarios, the driving data comprises vehicle trajectory information and corresponding scene context information, the plurality of driving scenarios comprising instructed driving events and uninstructed driving events;
encode, with a behavior model, the driving data, wherein the encoded driving data comprises an indication that a corresponding one of the plurality of driving scenarios comprises one of the instructed driving events or the uninstructed driving events;
determine, with a trajectory estimator processing the encoded driving data, one or more driving skill transitions based on a presence or an absence of the indication;
cause a teacher action model to learn a teacher policy encoding from the determined one or more driving skill transitions and the encoded driving data; and
generate, with the teacher action model, a teaching action for one of the plurality of driving scenarios.

2. The apparatus of claim 1, wherein the behavior model comprises a behavior encoder, a latent dynamics decoder model, and a decoder module.

3. The apparatus of claim 2, wherein the behavior encoder encodes the driving data comprising a past trajectory of a driver, control signals, and map information.

4. The apparatus of claim 2, wherein the latent dynamics decoder model is configured to learn skill transitions of a driver over time based on the teacher action.

5. The apparatus of claim 2, wherein the teacher policy encoding defines at least one of a verbal, visual, or sensory type teacher action.

6. The apparatus of claim 1, wherein the apparatus is configured to encode, with a past trajectory and scene encoder, a latent representation corresponding to the presence of instructions provided by an instructor during the plurality of driving scenarios comprising the instructed driving events.

7. The apparatus of claim 1, wherein the behavior model and the teacher action model define a multi-task artificial intelligence model.

8. A method for generating teaching actions for drivers, comprising:
obtaining driving data from a plurality of driving scenarios, the driving data comprises vehicle trajectory information and corresponding scene context information, the plurality of driving scenarios comprising instructed driving events and uninstructed driving events;
encoding, with a behavior model, the driving data, wherein the encoded driving data comprises an indication that a corresponding one of the plurality of driving scenarios comprises one of the instructed driving events or the uninstructed driving events;
determining, with a trajectory estimator processing the encoded driving data, one or more driving skill transitions based on a presence or an absence of the indication; and
generating, with a teacher action model, a teaching action for one of the plurality of driving scenarios.

9. The method of claim 8, further comprising causing the teacher action model to learn a teacher policy encoding from the determined one or more driving skill transitions and the encoded driving data.

10. The method of claim 9, wherein the teacher policy encoding defines at least one of a verbal, visual, or sensory type teacher action.

11. The method of claim 8, wherein the behavior model comprises a behavior encoder, a latent dynamics decoder model, and a decoder module.

12. The method of claim 11, wherein the behavior encoder encodes driving data comprising a past trajectory of a driver, control signals, and map information.

13. The method of claim 11, wherein the latent dynamics decoder model is configured to learn skill transitions of a driver over time based on the teacher action.

14. The method of claim 8, further comprising encoding, with a past trajectory and scene encoder, a latent representation corresponding to the presence of instructions provided by an instructor during the plurality of driving scenarios comprising the instructed driving events.

15. The method of claim 8, wherein the behavior model and the teacher action model define a multi-task artificial intelligence model.

16. A non-transitory computer-readable medium comprising processor-executable instructions that, when executed by one or more processors of an apparatus, causes the apparatus to perform a method comprising:
obtaining driving data from a plurality of driving scenarios, the driving data comprises vehicle trajectory information and corresponding scene context information, the plurality of driving scenarios comprising instructed driving events and uninstructed driving events;
encoding, with a behavior model, the driving data, wherein the encoded driving data comprises an indication that a corresponding one of the plurality of driving scenarios comprises one of the instructed driving events or the uninstructed driving events;
determining, with a trajectory estimator processing the encoded driving data, one or more driving skill transitions based on a presence or an absence of the indication; and
generating, with a teacher action model, a teaching action for one of the plurality of driving scenarios.

17. The non-transitory computer-readable medium of claim 16, further comprising causing the teacher action model to learn a teacher policy encoding from the determined one or more driving skill transitions and the encoded driving data.

18. The non-transitory computer-readable medium of claim 16, wherein the behavior model comprises a behavior encoder, a latent dynamics decoder model, and a decoder module.

19. The non-transitory computer-readable medium of claim 18, wherein the behavior encoder encodes driving data comprising a past trajectory of a driver, control signals, and map information.

20. The non-transitory computer-readable medium of claim 18, wherein the latent dynamics decoder model is configured to learn skill transitions of a driver over time based on the teacher action.
